(19) United States
(12) Patent Application Publication
(10) Pub. No.: US 2004/0006909 A1
(43) Pub. Date: Jan. 15, 2004

(54) Fishing lure

(76) Inventor: Larry Essad, Lake Hubert, MN (US)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 10/194,447

(22) Filed: Jul. 12, 2002

(51) Int. Cl. A01K 85/00

(52) U.S. Cl. 43/42.22

(57) ABSTRACT

A fishing lure having a lure body to which diving bills of various configurations may be affixed. The lure body includes a forwardly and sidewardly open slot into which a complementary configured portion of a diving bill may be inserted sideways, the slot and bill having locking configurations preventing the bill from separating from the lure body in response to forces tending to pull the bill forwardly from the slot.

### FIELD OF THE INVENTION

The present invention relates to an improved fishing lure. More particularly, the present invention relates to a fishing lure having a body that may be detachably interconnected with a variety of diving bills.

### BACKGROUND OF THE INVENTION

With the increased popularity in sport and contest fishing, the demand for more diverse fishing lures has developed. A great variety of fishing lure designs have been developed to meet this demand. One popular design is generally comprised of a body having a front head portion and a tail portion so as to be in the form of a minnow. These lures typically have a spoon or diving bill attached to the front head portion to cause the lure to submerge underwater or to otherwise cause the lure to move in a desired manner through the water. The position, size, and shape of the diving bill determines the particular depth and motion of the lure, and together with the fish-like shape of the body causes the lure to wiggle naturally as it is pulled through the water.

It is desirable to be able to easily mount a desired diving bill on the body of a lure. One approach seen in the prior art is to detachably connect diving bills to the bodies of lures. For example, in U.S. Pat. No. 4,215,507 to Russel, the diving bill is connected to the body by a rotating eye screw. In U.S. Pat. No. 4,697,378 to Tunstall, the bill and lure body are connected by forcibly snapping them together. This approach leads to problems because there is an uncertain snugness of fit between the lure and body. This increases the tendency for separation and a loose fit, thereby impairing the desired behavior of the lure and potentially causing it to travel erratically through the water.

Another approach as described in U.S. Pat. No. 4,619,067 to West is to threadingly interconnect the bill and the body. However, this is difficult and time consuming. A further approach is described by U.S. Pat. No. 5,353,433 to Ellis wherein the bill is releasibly locked into a body according to a snap-type action. Here, the bill is inserted into a slot by a forward, snap-like motion. Finally, in U.S. Pat. No. 4,944,112 to Garmany, an adaptable in situ bill is detachably affixed to the face of the body by sliding it into a channel within the face of the head portion of the body. However, the attaching of a bill to a body in a forward motion is problematic because it makes it more likely that the bill be removed from the body should a fish or weed tug on it in a forward motion.

Thus, it is an object of this invention to provide a lure assembly in which a diving bill mount may easily but securely be attached to a lure body. Specifically, it is desirable to mount diving bills to lure bodies without the need for any special tools or skills. It is further an object to ensure that the diving bill is properly secured within the body of the lure so that it will not be removed if it is tugged on by an attached fishing line or in a forward motion. The present invention accomplishes these objectives.

### SUMMARY OF THE INVENTION

The present invention provides a fishing lure comprising a lure body and a diving bill that is affixed to the body of the lure. One novel aspect of this present invention is that the diving bill is affixed to the lure body in a sideward format. The body contains a uniquely configured slot for receiving a corresponding end of a diving bill. This slot may be configured in any unique format so that only a corresponding edge of a diving bill may fit therein. In other words, the edge of the diving bill acts as a key to be inserted within the uniquely configured slot, which acts as a lock. The bill is inserted into this slot by lining up its edge to the side of the lure body and sliding it sideward into so that it is snuggly fit.

Once the bill edge has been received by the slot, it can only be removed again by the same sideward motion. Thus, when the bill is tugged in a forward motion, such as by a fish or a weed, it is locked into the slot and cannot be removed.

In one embodiment, an adhesive, desirably a water-proof adhesive, is employed to adhere the bill within the slot. In another embodiment, a fisherman may easily and quickly remove the bill and replace it with another by sliding it out of the slot in a sideward motion.

### BRIEF DESCRIPTION OF THE DRAWINGS

FIG. 1 is a cross-sectional side view of a first embodiment of the body of the fishing lure;

FIG. 2 is a perspective view shown from the top and one side of a diving bill configured to be affixed to the body of the first embodiment shown in FIG. 1;

FIG. 3 is a side view of the diving bill of FIG. 2;

FIG. 4 is a cross-sectional side view of the first embodiment wherein the diving bill is affixed to the body;

FIG. 5 is a cross-sectional side view of a second embodiment of the body of the fishing lure;

FIG. 6 is a cross-sectional side view of a third embodiment of the body of the fishing lure;

FIG. 7 is a cross-sectional side view of a fourth embodiment of the body of the fishing lure;

FIG. 8 is a cross-sectional side view of a fifth embodiment of the body of the fishing lure; and

FIG. 9 is a cross-sectional side view of a sixth embodiment of the body of the fishing lure.

### DETAILED DESCRIPTION OF THE PREFERRED EMBODIMENTS

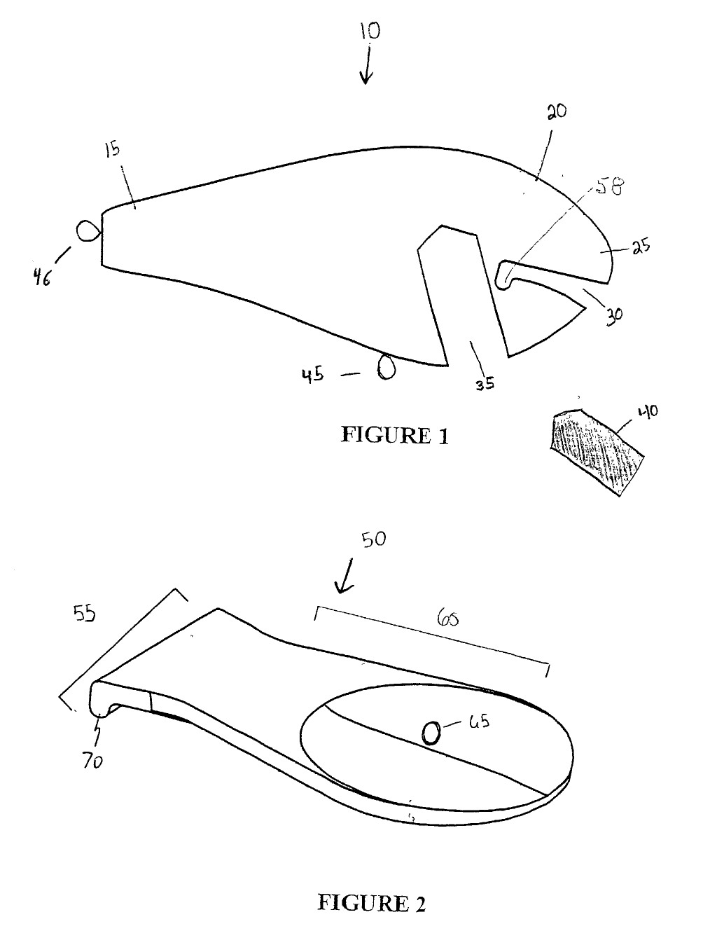

Referring to the drawings, the fishing lure of the present invention generally comprises four basic body parts, namely a body, a diving bill, a weight member, and hook assemblies attached about the various parts of the body. FIG. 1 depicts a cross-sectional side view of a first embodiment of a body of the fishing lure. The body 10 has a tail portion 15 at it rear end and a head portion 20 at its front end. The head portion 20 further contains a nose 25, the overall shape of the body here being typified as a minnow. There is a uniquely configured slot 30 extending inward latitudinally from the nose 25 and extending across the width of the body 10. The slot 30 is open forwardly and sideward about the front head portion 20. In this embodiment, the slot 30, beginning from the nose 25 of the head portion 20 and extending inward, is configured in the form of an “L-shape.” The body preferably is made of a plastic such as polyurethane or polystyrene, a wood such as cedar or balsa.

Note that it should be apparent to one skilled in the art that the slot 25 may be configured in any suitable formation as further described below.

FIG. 1 further displays a cavity 35 formed in a bottom portion of the head portion 20. The cavity 35 is adapted to receive a separate weight member 40. The weight member 40 serves to provide a required weight for effective casting with a fishing rod and lowers the overall center of gravity of the lure to stabilize its action as a fisherman retrieves it through the waters. The weight member 40 is preferably made of lead or any other suitable comparatively heavy material. In the preferred embodiment, both the cavity 35 and the weight member 40 are bullet-shaped so that a snug fit may be obtained. The weight member 40 is held inside of the cavity 35 by any suitable manner, e.g., by a press-fit or through use of an adhesive. This weight member 40 is purely optional, as it may be desired to keep the lure in the form of a floating type by simply not using the weight member. It should further be apparent to one skilled in the art that the cavity 35 may be located in any suitable portion of the body 10 and may be of any suitable shape to hold a weight member.

FIG. 1 further depicts separate hook assemblies 45 and 46. In the preferred embodiment, hook assembly 45 is attached on the middle of the underside of the body 10 and hook assembly 46 is attached on the rearmost portion of the tail portion 15. These hook assemblies are usually in the form of screws inserted into the body, wherein the top of the screw is configured as a circle and has a metal eyelet attached about the circle. Any suitable fishing apparatus may be attached to these hook assemblies. Typically, attached to the hook assemblies are the conventional three-barb fishhooks generally known as treble hooks. Other fishing and decorative apparatuses could also be connected to the assemblies 45, 46, such as those that include fish markings thereon. While in the preferred embodiment, the hook assemblies 45, 46 are located on the middle of the underside of the body 10 and on the rearmost portion of the tail 15, it should be apparent to one of skill in the art that any number of hook assemblies may be attached about any portion of the body 10. Preferably, the body 10 will be made of plastic or any other suitable material and will be painted or colored with fish markings thereon.

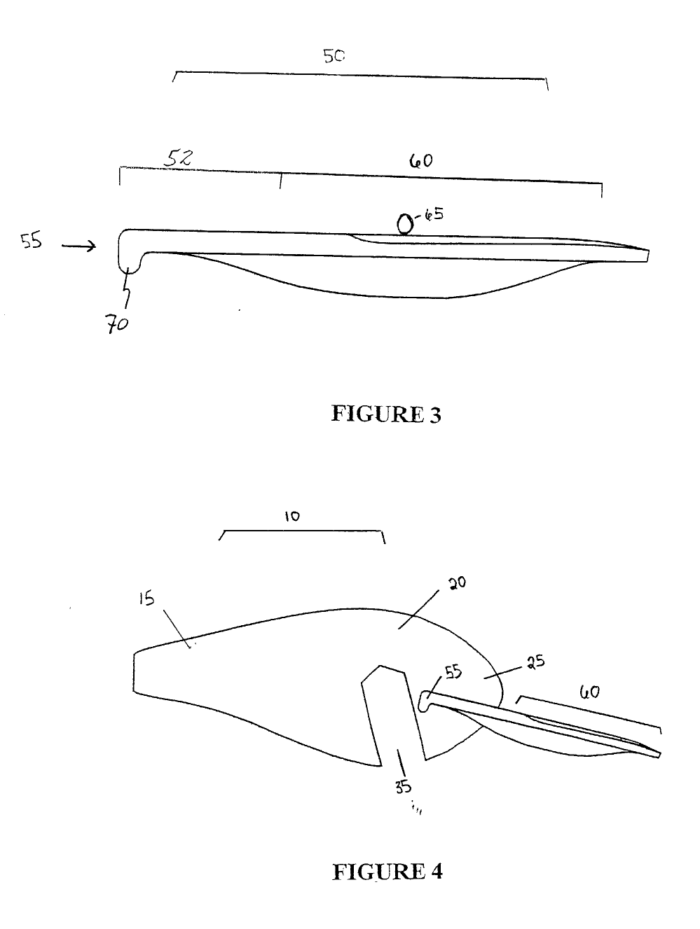

FIGS. 2 and 3 display a diving bill 50 configured to be affixed to the body 10 of the first embodiment of this invention. Here, the diving bill 50 contains a generally planar rear portion 52 having an edge 55, and a body portion 60. The rear portion, including the edge 55, is configured to be received by the uniquely configured slot 30. In other words, the edge 55 is made so that it will mate within slot 30 and hold via a compression fit.

The edge 55 includes one or more projecting portions 70 that extend away from the plane of the rear portion of the diving bill and that are configured to be reclined in a similarly shaped cavity (58 in FIG. 1) to lock the bill to the body against forces tending to pull the bill forwardly from the body. This invention may also be in the form of a kit, wherein several diving bills 50 are available, each having the same edge 55 so as to be mated with a single particular lure body 10. However, the different diving bills 50 may have differently sized and shaped body portions 60. The body portion 60 of the bill 50 may be changed to any size or shape, depending on the desired diving depths and movement sought for the entire fishing lure.

A fishing line eye assembly 65 may be mounted on the body portion 60 of the diving bill 50. Preferably, the eye assembly 65 is mounted on the middle of the upper side of the body portion 60. However, it should be apparent that any number of eye assemblies might be mounted on any suitable location about the diving bill. Like the hook assemblies 45, 46 mounted on the lure body, this eye assembly 65 is typically in the form of a screw inserted into the body 60, wherein the top of the screw is configured as a circle and has a metal eyelet attached about the circle for connection to a fishing line.

In one embodiment, in which the diving bill is detachable from the body, a fisherman will first select one of several available diving bills having differently sized and shaped body portions but having the same edge configuration. This selection will be based on the desired swimming depth of the lure or based on the desired swimming pattern or motion of the lure in the water. Once selected, the fisherman will line up the edge of the selected diving bill along the side of the lure body so that the edge matches identically the configuration of the slot. Then, the edge will be slid sideward into the slot so that it is snugly fit. This inserting of the diving bill into the lure body may be done before or after the lure has been connected to a fishing line. This process may be repeated if fishing conditions change and a differently sized diving bill is desired. FIG. 4 displays the edge 55 of the diving bill 50 in this detachably affixed position within the uniquely configured slot 30 of the lure body 10.

Beside the slot 30 and edge 55 configuration shown and described, persons of ordinary skill in the art will recognize that other equivalent slots 30 and edges 55 may be configured in other suitable manners. The slot 30 shown and described above extends across the entire width of the body 10. In alternative embodiments, the slots 30 need only extend partially across the width of the body 10. In such configurations, the slot 30 would be located on only one side of the body 10. That is, the slot 30 would only be open on one side of the body 10. The edge 55 of the bill 50 could be slid laterally with respect to the body 50 in and out of this open side of the slot 30. The edge 55, of course, would be shorter, matching the lateral extent and shape of the slot 30.

Besides varying the lateral extent of the slots 30, the lateral direction may also be varied. The slots 30 shown and described above extend in a direction transverse to the longitudinal centerline (i.e., a line running from the center of the nose 25 to the center of the tail 15) of the body 10. It should be apparent to one of skill in the art that the slots may be configured in other directions. For instance, the slot need not extend perpendicular to the longitudinal centerline. Instead, the slot 30 could extend from one side of the body 10 across the width of the body 10 in upward, downward, forward, or rearward directions to the other side of the body 10. Desirably, the edge 55 remains properly secured within the slot 30 even when subjected to forces experienced during normal use. For instance, during normal use, a fishing line attached at eye 65 may tug the diving bill 50 generally forwardly. Additionally, hooks attached at hook assemblies 45, 46 may pull the body 10 generally rearwardly. Accordingly, the slot 30 should not be oriented parallel with the longitudinal centerline. If oriented parallel to the centerline, the edge 55 may be more easily pulled from the slot 30 by a generally forward or rearward force. Thus, it is preferred that the slot 30 extend across the width of the body 50 at an angle other than 0 or 180 degrees, preferably between 45 and 135 degrees, and most preferably at about 90 degrees.

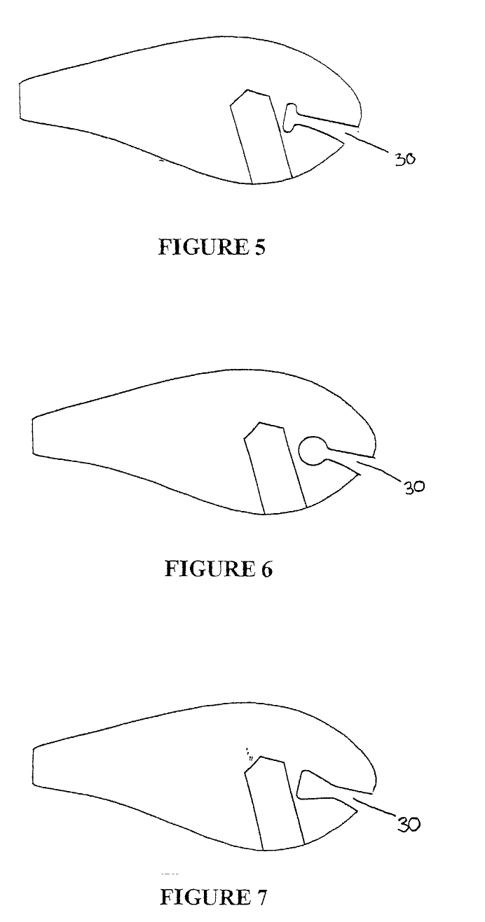

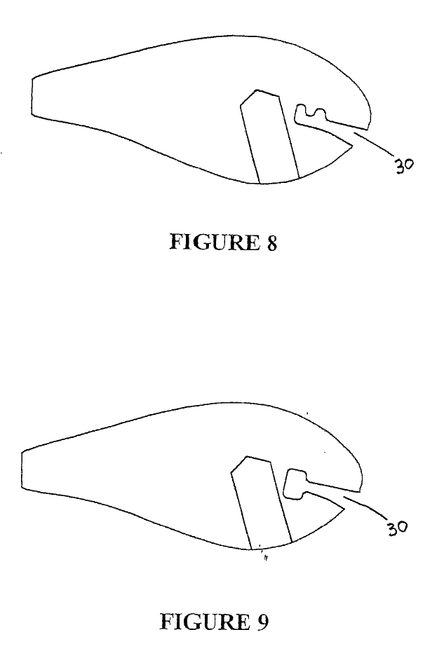

In addition to varying the length and angle of the slot 30 and edge 55, the shape of the projecting portion(s) 70 of the edge 55 may also be varied as long as the corresponding body 10 includes a receptive slot 30, and as long as the slot 30 and edge 55 combination resists separation from generally forward or rearward forces. For instance, FIGS. 5-9 display alternative embodiments of slot 30, as it extends inward from the nose 25 and across the width of body 10. In FIG. 5, the slot is configured as a T-shape. In FIG. 6, the slot is configured as a channel ending in a circular shape. In FIG. 7, the slot is configured as channel ending in a triangular shape with the point at the bottom, facing the nose 25. In FIG. 8, the slot is configured as an F-shape. Finally, in FIG. 9 the slot is configured as a channel ending in a rectangle. The projecting portion(s) 70 of the edge 55 (as shown in FIG. 3) thus prevents the bill 50 from sliding forwardly with respect to the body 10. As indicated by the corresponding slots in FIGS. 5-9, the projecting portion 70 may be formed in many different suitable shapes and sizes.

While a preferred embodiment of the present invention has been described, it should be understood that various changes, adaptations and modifications may be made therein without departing from the spirit of the invention and the scope of the appended claims.

What is claimed is:

1. A fishing lure assembly, comprising:
a lure body having front head and rear tail portions and having opposing sides, the lure body having a uniquely configured slot extending laterally across the lure body, the slot being open to the front head portion and to at least one side of the lure body; and
a diving bill having a body portion and an edge, the edge being configured to be removably receivable within the uniquely configured slot, the slot receiving the edge of the diving bill when the edge is moved in a sideward motion relative to the lure body, the diving bill edge and the slot being adapted to resist separation from each other when the diving bill is subjected to generally forwardly directed forces.

2. The fishing lure assembly of claim 1 wherein the uniquely configured slot is configured as a T-shape.

3. The fishing lure assembly of claim 1 wherein the uniquely configured slot is configured as a channel ending in a circular shape.

4. The fishing lure assembly of claim 1 wherein the uniquely configured slot is configured as a channel ending in a triangular shape.

5. The fishing lure assembly of claim 1 wherein the uniquely configured slot is configured as an F-shape.

6. The fishing lure assembly of claim 1 wherein the uniquely configured slot is configured as a channel ending in a rectangle.

7. The fishing lure assembly of claim 1 wherein the edge includes a flange adapted to prevent movement of the bill from the lure body in a generally forward direction.

8. The fishing lure assembly of claim 1 wherein the uniquely configured slot extends across the entire width of the lure body.

9. The fishing lure assembly of claim 1 further wherein the lure body contains a cavity for receiving a weight member.

10. The fishing lure assembly of claim 1 wherein the slot extends from the at least one side of the lure body in a direction transverse to a longitudinal centerline running from the front head to the rear tail of the lure body.

11. The fishing lure assembly of claim 1 further containing one or more hook assemblies mounted on the lure body.

12. The fishing lure assembly of claim 11 wherein the one or more hook assemblies are configured as a screw having a circular top with a metal eyelet attached about the circular top.

13. The fishing lure assembly of claim 1 wherein the lure body is made of polyurethane, polystyrene, cedar wood or balsa wood.

14. The fishing lure assembly of claim 1 wherein the lure body is painted with fish markings thereon.

15. The fishing lure assembly of claim 1 wherein the bill is secured within the slot with an adhesive.

16. A fishing lure kit, comprising:
a lure body having front head and rear tail portions and having opposing sides, the lure body having a uniquely configured slot extending laterally across the lure body, the slot being open to the front head portion and to at least one side of the lure body; and
two or more diving bills, each diving bill having a body portion and an edge, the body portions of each diving bill being shaped differently, the slot being configured to removably receive the edge of any one of the diving bills when such edge is moved in a sideward motion relative to the lure body, each diving bill edge and the slot being adapted to resist separation from each other when such diving bill is subjected to generally forwardly directed forces.

17. A method of attaching a diving bill to a body of a fishing lure, comprising:
providing a fishing lure body having front head and rear tail portions and having opposing sides, the lure body having a uniquely configured slot extending laterally across the lure body, the slot being open to the front head portion and to at least one side of the lure body; and
selecting a diving bill having a shape and size to cause the fishing lure body to move in a predetermined manner within the water, the diving bill having a body portion and an edge, the edge being configured to be removably receivable within the uniquely configured slot, the slot receiving the edge of the diving bill when the edge is moved in a sideward motion relative to the lure body, the diving bill edge and the slot being adapted to resist separation from each other when the diving bill is subjected to generally forwardly directed forces; and
inserting the edge of the diving bill into the uniquely configured slot by sliding the edge into the slot in a sideward motion.

18. The method of claim 17 including securing the bill within the slot with an adhesive

19. The fishing lure assembly of claim 1 wherein the lure body is made of plastic.
